(19) United States
(12) Patent Application Publication
(10) Pub. No.: US 2021/0062951 A1
(43) Pub. Date: Mar. 4, 2021

(54) MULTI-FUNCTIONAL WATER AERATION CONDUIT FOR A CONTAINER DRAIN OUTLET

(71) Applicant: Santiva Outdoors, L.L.C. - Series IP, Dallas, TX (US)

(72) Inventors: William Jason Cohen, Dallas, TX (US); Tomas L. Ortiz Ferrer, Sai Kung - NT (CN); Nicholas Zager, New York, NY (US)

(21) Appl. No.: 16/898,531

(22) Filed: Jun. 11, 2020

Related U.S. Application Data
(60) Provisional application No. 62/860,083, filed on Jun. 11, 2019.
(60) Provisional application No. 62/914,687, filed on Oct. 14, 2019.

(51) Int. Cl. F16L 39/00; A01K 97/05; A01K 63/04

(52) U.S. Cl. CPC F16L 39/00; A01K 63/042; A01K 97/05

(57) ABSTRACT

Apparatus and methods relate to a bi-directional air and water conduit system. In an exemplary embodiment, the conduit system may be provided with an adapter casing. An internal member may be releasably coupled to the adapter casing. A plurality of channels may longitudinally extend through the internal member. The adapter casing, internal member, and plurality of channels may permit fluid to ingress and egress a container. The plurality of channels may be mutually isolated. The adapter casing may be configured to engage with a drain of a cooler. Various embodiments may, for example, advantageously enable supply of fresh water and/or air and evacuation of stagnant water and/or air to facilitate a robust environment for bait in a container.

### CROSS-REFERENCE TO RELATED APPLICATIONS

This application claims the benefit of U.S. Provisional Application Ser. No. 62/860,083, titled “MULTI-FUNCTIONAL WATER AERATION CONDUIT FOR A CONTAINER DRAIN OUTLET,” filed by William Jason Cohen, et al., on Jun. 11, 2019.

This application claims the benefit of U.S. Provisional Application Ser. No. 62/914,687, titled “IMPROVED MULTI-FUNCTIONAL WATER AERATION CONDUIT FOR A CONTAINER DRAIN OUTLET,” filed by William Jason Cohen, et al., on Oct. 14, 2019.

This application incorporates the entire contents of the foregoing application(s) herein by reference.

### TECHNICAL FIELD

Various embodiments relate generally to aeration of bait tanks.

### BRIEF DESCRIPTION OF THE DRAWINGS

FIG. 1 depicts a perspective view of an exemplary bi-directional air and water conduit system in association with an exemplary cooler.

FIGS. 2A-2K depict a various view of an exemplary bi-directional air and water conduit system.

FIGS. 3A and 3B depict exploded views of an exemplary bi-directional air and water conduit system.

FIGS. 4A-4M depict various views illustrating various aspects of an exemplary bi-directional air and water conduit system.

Like reference symbols in the various drawings indicate like elements.

### DETAILED DESCRIPTION OF ILLUSTRATIVE EMBODIMENTS

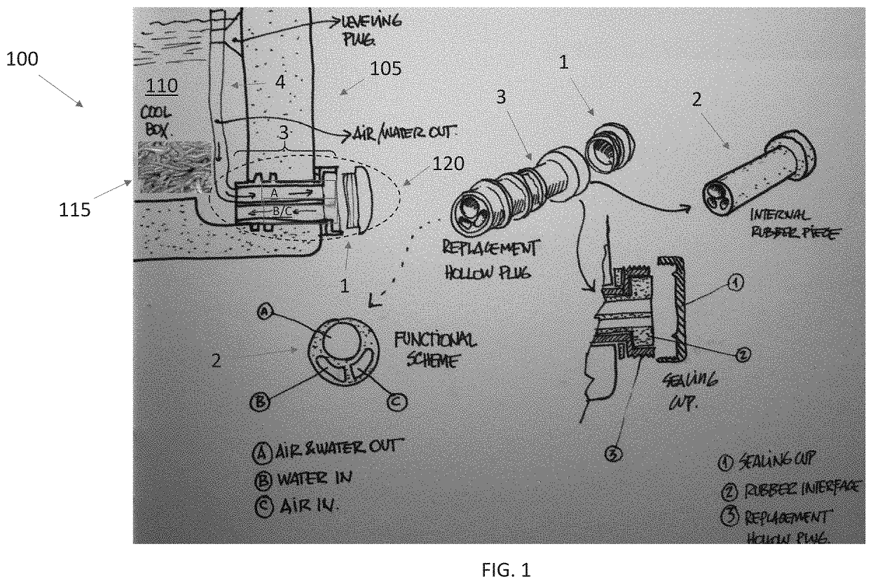

FIG. 1 depicts a perspective view of an exemplary bi-directional air and water conduit system in association with an exemplary cooler. A system 100 includes a cooler 105. The cooler 105 in this exemplary scenario has been converted into a bait tank. The cooler 105 stores water 110 and live bait 115 within its interior. To properly maintain the bait 115 in the cooler/bait tank 105, the bait will require a supply of oxygen rich water that is also fresh from a water source. Accordingly, an exemplary bi-directional air and water conduit system 120 may be attached to the drain outlet of the cooler 105 that provides for combined air into/out of and water into/out of the interior of the cooler 105.

An exemplary construction of a bi-directional air and water conduit system 120 is as follows. A system 120 may include a sealing cup/cap 1 configured to close off a distal end of the system 120. The system 120 may include a longitudinally extending internal member 2, the distal end of which may be closed off by the cup/cap 1. The internal member 2 is inserted into a hollow adapter casing 3. The adapter casing 3 may be adapted to mechanically couple at the drain outlet of the cooler 105. For example, the adapter casing 3 may include fixating structures that engage complementary fixating structures of the cooler's drain. The cup/cap 1 may also mechanically couple via fixating structures to the internal member 2 or the adapter casing 3.

The internal member 2 includes multiple longitudinally extending and mutually isolated channels A, B, and C. Each channel may be assigned a specific purpose in facilitating a robust environment for the bait 115 stored in the cooler 105. For example, a first channel A may act as a combined drain conduit through which both air and water may exit the cooler 105. Air and water may be evacuated from the cooler via a drain line 4, which may be coupled at a proximal end of the internal member 2 to the first channel A. A second channel B may act as a water input conduit through which a fresh supply of water may be injected into the cooler 105. A third channel B may act as an air input conduit through which a fresh supply of air (including oxygen) may be supplied to the interior contents of the cooler 105 (including the bait 115). Accordingly, the system 120 may advantageously provide for multiple water/air input/output conduits to both (1) evacuate the inside of the cooler of stagnant air and water, and (2) supply the inside of the cooler with an external source of air and water to maintain a livable for the live bait 115. In this sense, the system 120 may be referred to in various examples as a “4-in-1” system (e.g., water-in, water-out, air-in, and air-out).

In various examples, the system 120 may be attached to a pump, which may provide the necessary force to pump water into the cooler 105 via one of the channels A, B, C. For example, the water input channel B may be operably coupled (e.g., via a hose or line) to a water pump to provide an external supply of water into the cooler 105. The pump may cooperate with the drain line 4 to regulate a proper water level inside of the cooler 105. In some exemplary embodiments, the air input channel B may be operably coupled (e.g., via a hose or line) to an air pump to provide an external supply of air into the cooler 105.

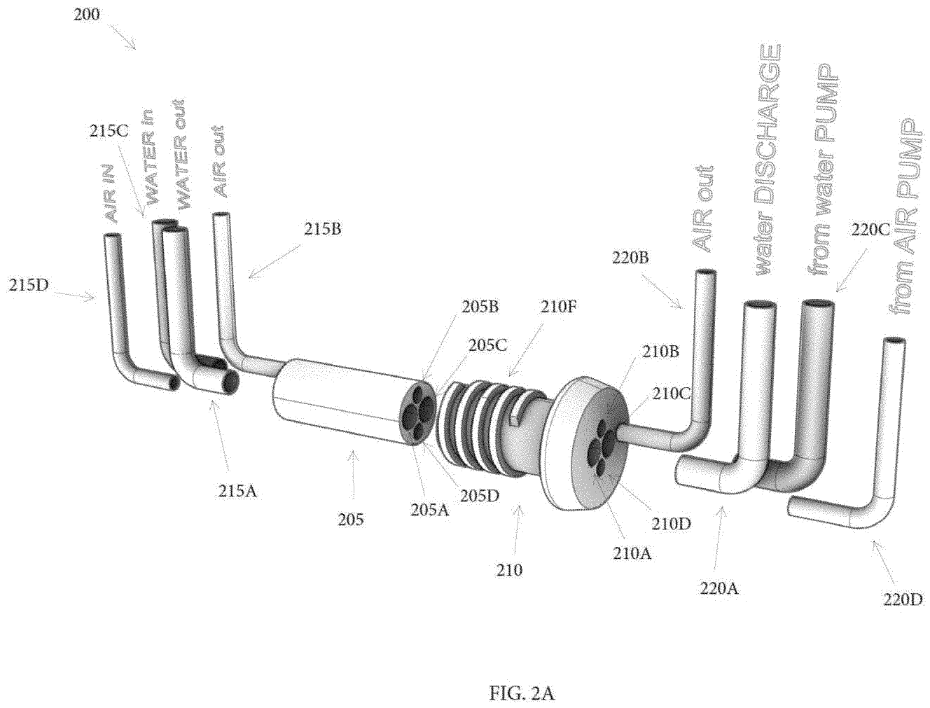

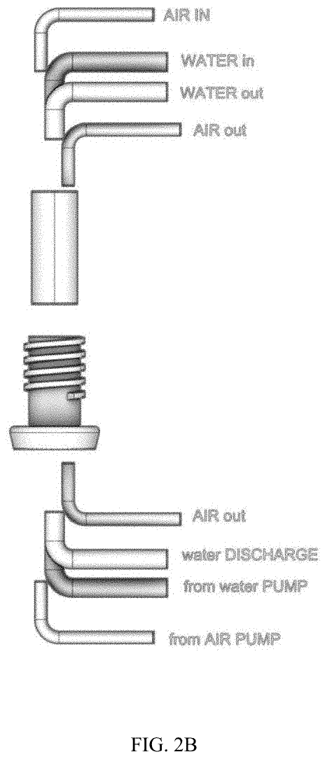

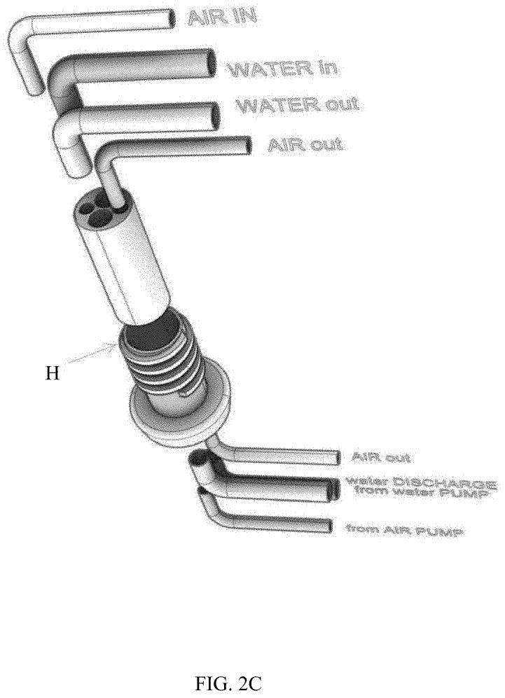

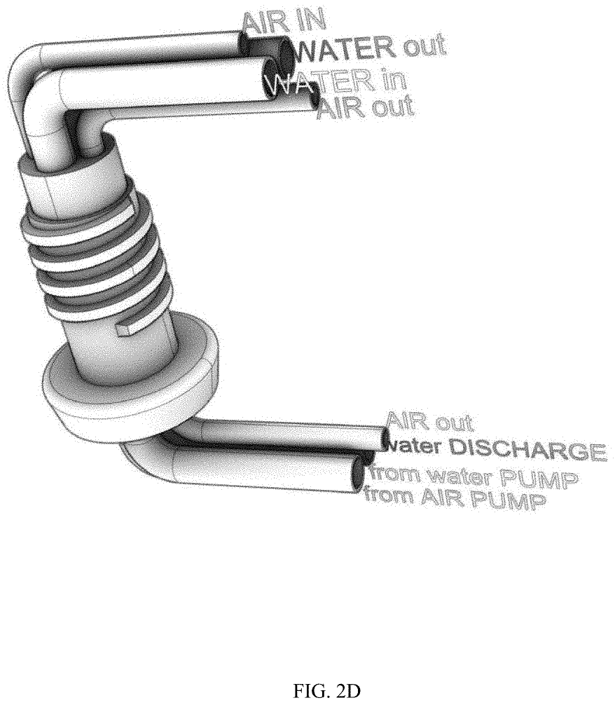

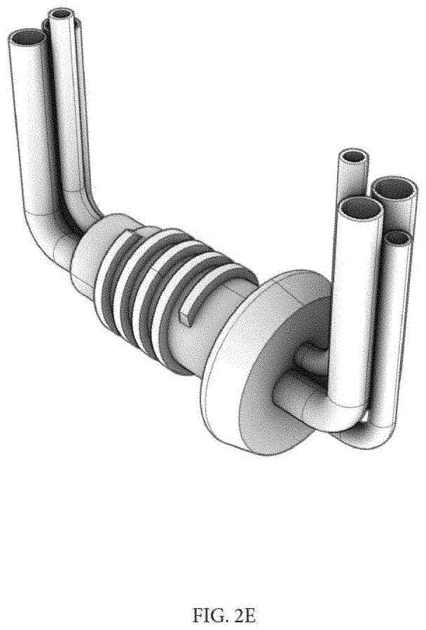

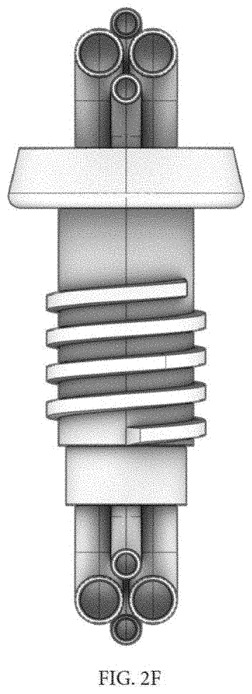

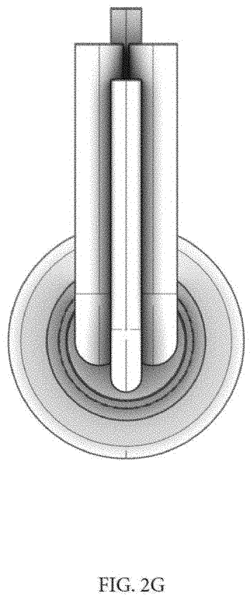

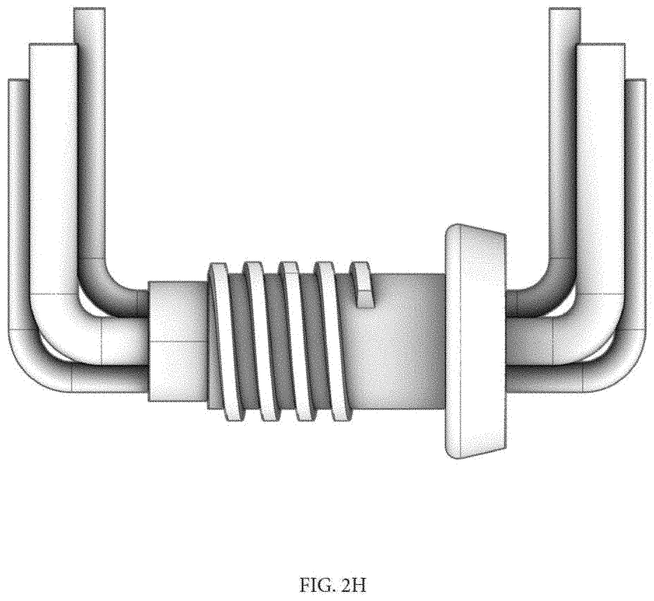

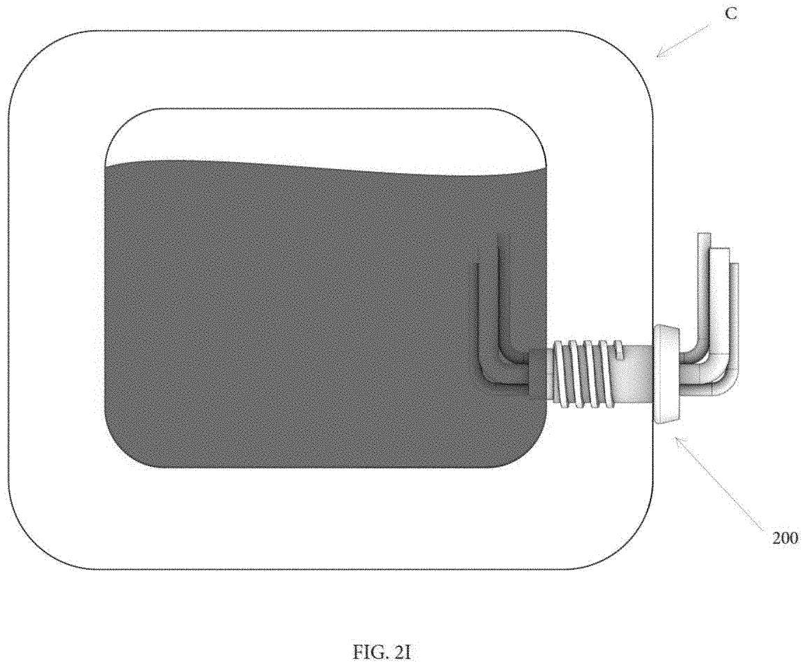

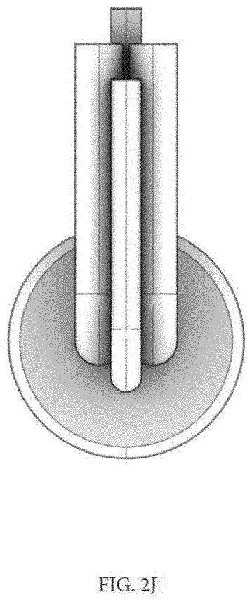

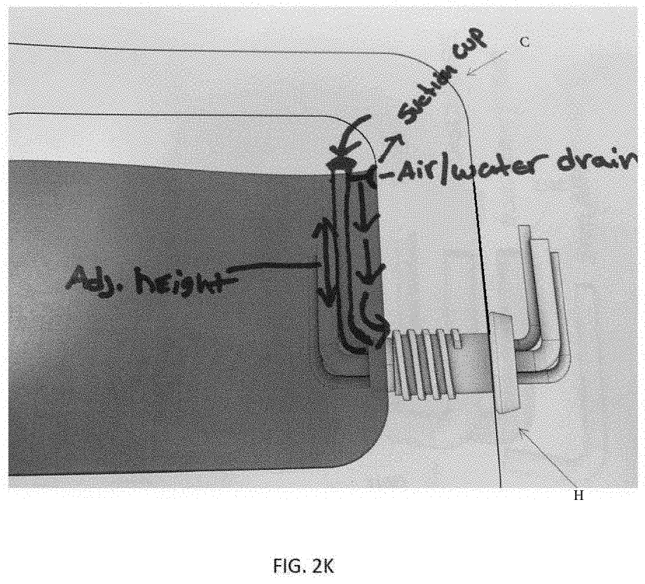

FIGS. 2A-2K depict a various view of an exemplary bi-directional air and water conduit system. A bi-directional air and water conduit system 200 includes a longitudinally extending internal member 205. Extending longitudinally within the internal member 205 are multiple channels/conduits 205A-205D. Each channel may be assigned a specific purpose in facilitating a robust environment for bait stored in a cooler. For example, channel 205A may be a dedicated water output channel, channel 205B may be a dedicated air output channel, channel 205C may be a dedicated water input channel, and channel 205D may be a dedicated air input channel. In various embodiments, each channel may be (laterally) isolated from every other channel (e.g., each channel may be formed as an isolated cylinder passing through longitudinally through the length of the internal member 205).

The internal member 205 is configured to be inserted into a hollow interior H of an adapter casing 210. For example, an outer diameter of the internal member 205 may be approximately equal to an inner diameter of the hollow interior of the casing 210. In various embodiments, the coupling between the member 205 and the casing may be a fit coupling such as a clearance fit, location/transition fit, or (light) interference fit. A transition fit and/or (light) interference fit may advantageously create a seal between an outer surface of the member 205 and an inner surface of the casing 210.

The adapter casing 210 may define the hollow interior H at a proximal end of the casing 210, and multiple ports/channels/conduits 210A-210D at a distal end of the casing 210. In various examples, there may be fluid communication between the ports 210A-210D and the interior H when the casing 210 is not yet assembled with the other parts of the system 200. Each port may be assigned a specific purpose in facilitating a robust environment for bait stored in a cooler. For example, port 210A may be a dedicated water output port, port 210B may be a dedicated air output port, channel 210C may be a dedicated water input port, and channel 210D may be a dedicated air input port. In various embodiments, each port may be (laterally) isolated from every other port when the member 205 is operably coupled inside of the casing 205. Each port 210A-210D may operably interface with an associated channel 205A-205D to facilitate ingress/egress of water/air into/out of a cooler. The casing 210 also includes fixating structures 210F. The fixating structures 210F in this exemplary depiction are threads configured to engage with complementary threads of a drain of a cooler to mechanically couple the system 200 to the drain of the cooler.

The channels 205A-205D extend from a proximal end of the member 205 to a distal end of the member 205. The system 200 includes multiple proximal tubes/lines 215A-215D, each associated and configured to operably interface with the distal ends of respective channels 205A-205D. For example, each line 215A-215D may be inserted into an associated channel 205A-205B and form a proper fit coupling to create an operable seal to (fluidly) isolate each line/channel from every other line/channel Similar to above, line may be assigned a specific purpose in facilitating a robust environment for bait stored in a cooler. Each line 215A-215B may be located at a distal end of the system 200, and reside inside of a container (such as a cooler) while the system 200 is mechanically attached to a drain of the container.

The system 200 includes multiple distal tubes/lines 220A-220D, each associated and configured to operably interface with the proximal ends of respective channels 205A-205D. Each line 220A-220D may interface with an associated channel 205A-205D via an associated port 210A-210B. For example, each line 220A-220D may be inserted into an associated port 210A-210B and form a proper fit coupling to create an operable seal to (fluidly) isolate each line/channel/port from every other line/channel/port. Some lines 220A-220D, in various implementations, may be operably coupled to an associated pump (e.g., air or water pump). Accordingly, an exemplary mode of operation of the system 200 may be as follows (see explanation in next paragraph).

Stagnant or old water in a container may be discharged/evacuated from the container by flowing through line 215A, through channel 215A, past port 210A, and through line 220A to a discharge location. Stagnant or old air in a container may be discharged/evacuated from the container by flowing through line 215B, through channel 215B, past port 210B, and through line 220B to a discharge location. An external source of water may be supplied/delivered to the container by being pumped through line 220C, past port 210C, through channel 205C, and through line 215C to the interior of the container. An external source of air may be supplied/delivered to the container by being pumped through line 220D, past port 210D, through channel 205D, and through line 215D to the interior of the container. Accordingly, the system 120 may advantageously provide for multiple water/air input/output conduits to both (1) evacuate the inside of the cooler of stagnant air and water, and (2) supply the inside of the cooler with an external source of air and water to maintain a livable for the live bait 115. In this sense, the system 200 may advantageously yield multiple functions (e.g., water-in, water-out, air-in, and air-out) in a single modular system 200.

FIGS. 2A-2C depict various exploded views of an exemplary bi-directional air and water conduit system 200. FIGS. 2D-2H and 2J depict various fully assembled views of an exemplary bi-directional air and water conduit system 200. FIG. 21 depicts an exemplary deployment scenario where the system 200 is deployed on an exemplary container C. The container C may be a cooler having a drain outlet, where the system 200 is mechanically and operably coupled to the drain of the cooler to facilitate a robust environment for any bait that may be stored inside of the container C. FIG. 2K depicts a drain system employed with a bi-directional air and water conduit system. For example, once a container (e.g., cooler/bucket) is filled with water, a drain conduit may be installed that allows water from the high water level mark to flow down the drain and out the air/water out port of the connection system. The height of the drain conduit may be determined by adjustable drain tube (e.g., a telescoping tube) that may mount to the inside of the container (e.g., via a suction cup) and connect to the water/air out port of the connection system.

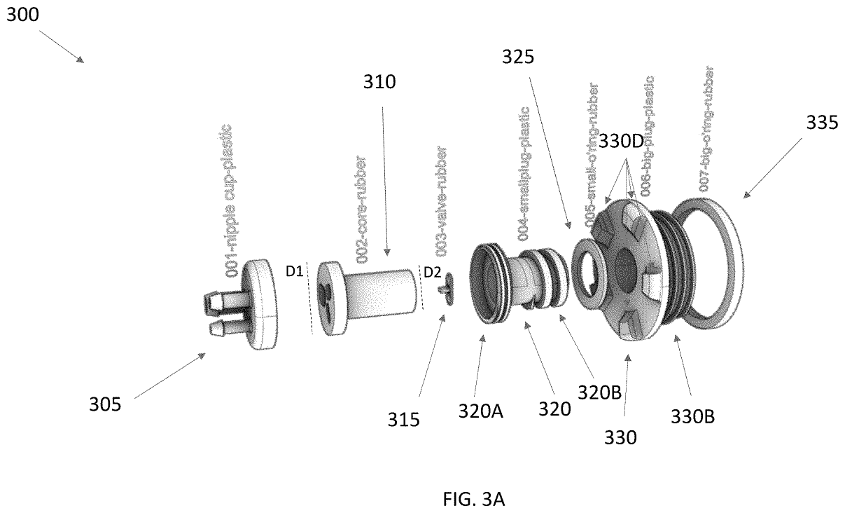

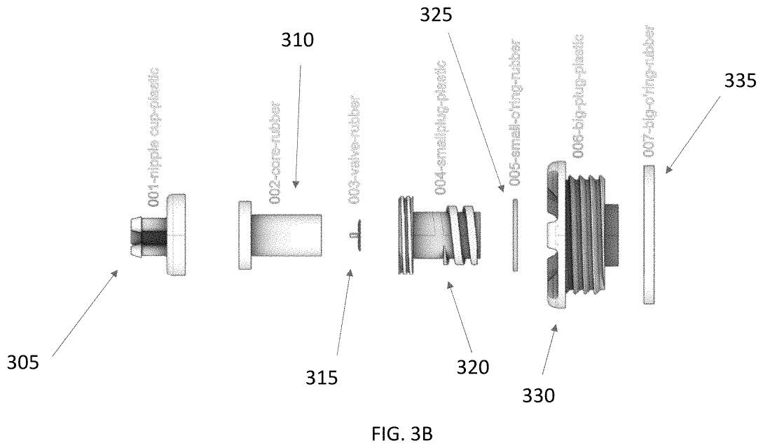

FIGS. 3A and 3B depict exploded views (perspective and side elevational, respectively) of an exemplary bi-directional air and water conduit system. A system 300 includes (at a distal end) a nipple cup 305. Each nipple of the nipple cup 305 may sealingly engage with an associated tube/line (e.g., similar to the lines 220A-220D) at a distal end of the system 300. A proximal end of the nipple cup 305 is configured to sealingly engage with a longitudinally extending internal core 310. The core may include individual longitudinally extending and (laterally) isolated channels (e.g., similar to the channels A-C and 205A-205D) that are each associated with a nipple of the nipple cup 305. The system 300 includes a valve 315. The valve 315 may be configured to limit the flow of fluids (air or liquid) through at least one of the channels of the core 310. In some examples, the valve 315 may act as a one-way valve. For example, the valve 315 may permit an ingress flow of water/air into the container via the bottom two nipples, while preventing an egress flow of water/air out of the container via the bottom two nipples. In such an exemplary case, the bottom two nipples/channels may be respectively purposed for water-in and air-in, while the upper nipple/channel may be purposed for combined water-out and air-out. The core 310 in this embodiment has a first diameter D1 at a distal end and a second diameter D2 at a proximal end.

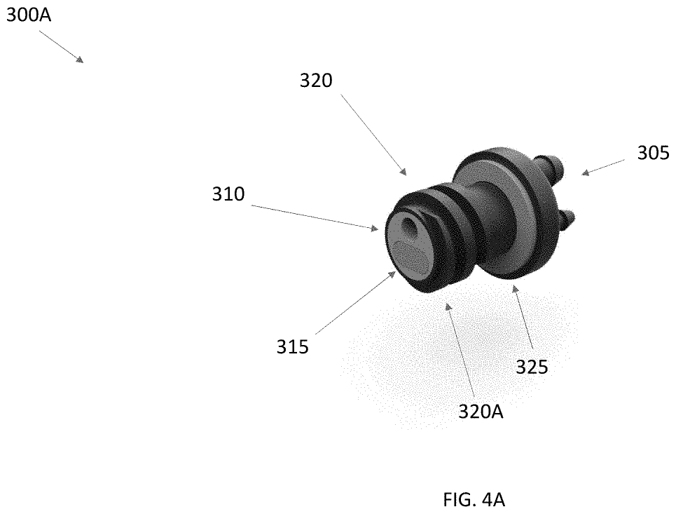

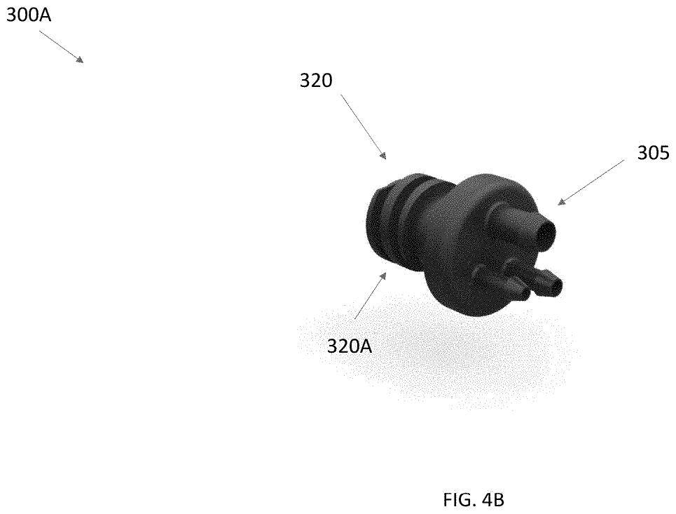

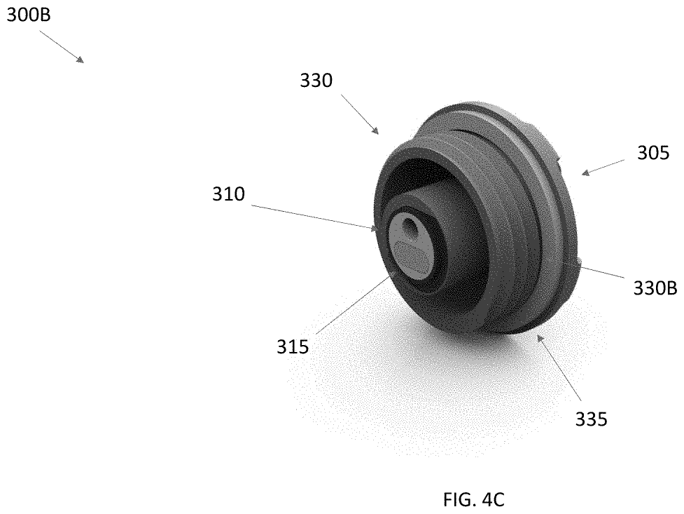

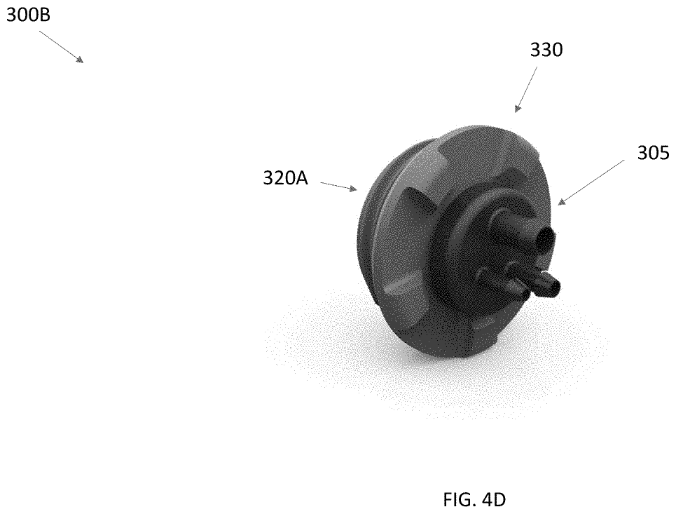

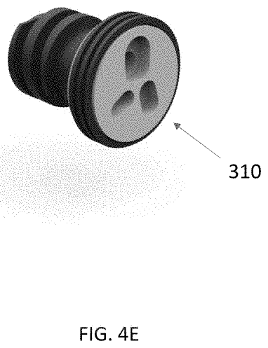

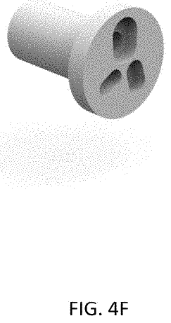

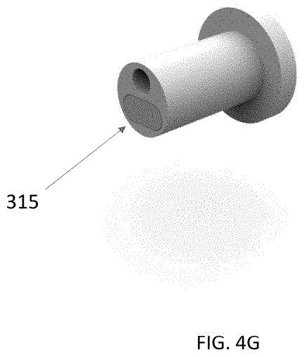

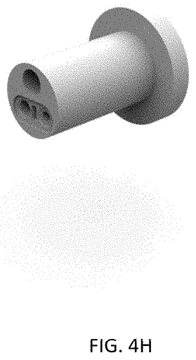

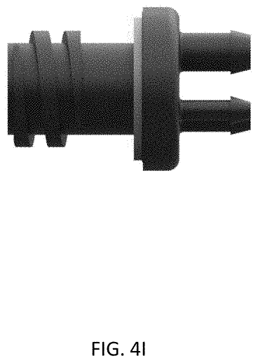

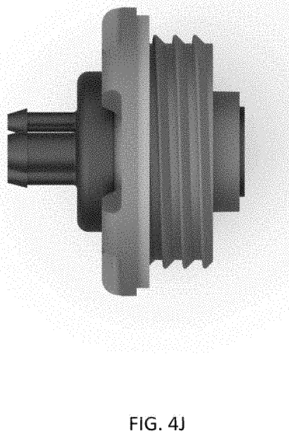

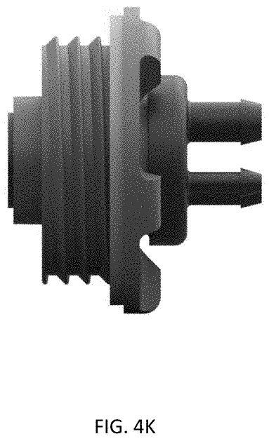

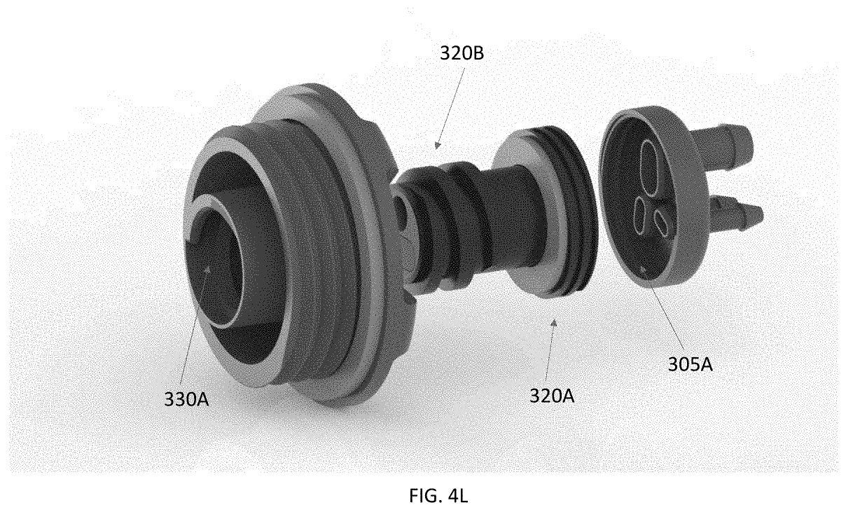

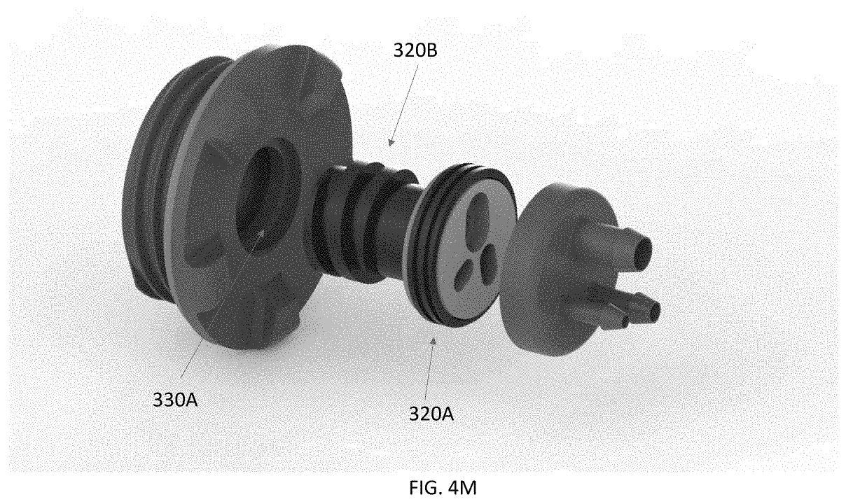

The system 300 further includes a small adapter casing 320. The small adapter casing 320 includes fixating structures 320A and 320B (e.g., threads). The first fixating structure 320A may be located at a distal end of the small adapter casing 320 and be configured to mechanically couple with complementary fixating structures 305A of the nipple cup 305 (see FIG. 4L) to mechanically and fixedly couple the cup 305 to the casing 320. When so coupled, the core 310 may fit snugly within the interior void defined by the combined cup 305 and casing 320. The second fixating structure 320B may be located at a proximal end of the large adapter casing 330 and be configured to mechanically couple with complementary fixating structures of a (small) drain of a container such as a cooler (e.g., similar to the exemplary depiction in FIGS. 1 and 21). The system 300 may include a small washer or O-ring 325, which may aid in creating a fluid-tight seal between the small casing 320 and the drain outlet of the container.

The system may include a large adapter casing 330. The large adapter casing 330 may be configured to receive the small adapter casing 320. The large adapter casing 330 may include fixating structures 330A and 330B (e.g., threads). The first fixating structure 330A may occupy a hollow interior of the large adapter casing 330 and be configured to mechanically couple with complementary fixating structures 320B of the small adapter casing 320 to mechanically and fixedly couple the small casing 320 to the large casing 330. When so coupled, the small casing 320 may fit within a central elongated interior void defined by the inner surfaces of the large casing 330. The second fixating structure 330B may be located at a proximal end of the large adapter casing 330 and be configured to mechanically couple with complementary fixating structures of a (large) drain of a container such as a cooler (e.g., similar to the exemplary depiction in FIGS. 1 and 21). The system 300 may include a large washer or O-ring 335, which may aid in creating a fluid-tight seal between the large casing 330 and the drain outlet of the container. The large casing 330 may also include multiple (integrally formed) hand-torque members 330D to ease rotation of the casing 330 for connecting to the drain outlet.

In various examples, different containers may have different sized drain outlets. A small casing 320 may be dimensioned and adapted to connect to a first (smaller) sized drain of a (first) container. A larger casing 330 may be dimensioned and adapted to connect to a second (larger) sized drain of a (second) container. Accordingly, the adapter casings 320, 330 may be provided in a kit that advantageously allows a user to adapt the system 300 to containers/coolers/drains of different sizes.

FIGS. 4A-4M depict various views illustrating various aspects of an exemplary bi-directional air and water conduit system. FIGS. 4A and 4B depict front and back perspective views illustrating fully assembled state of an exemplary bi-directional air and water conduit system 300A adapted for containers with smaller sized drains. FIGS. 4C and 4D depict front and back perspective views illustrating a fully assembled state of an exemplary bi-directional air and water conduit system 300B adapted for containers with larger sized drains. FIGS. 4E-4H depict an exemplary disassembly progression of the system 300A. FIG. 41 depicts a side elevational view of the system 300A, while FIGS. 4J and 4K depict side elevational views of the system 300B. The system 300A may be used for a container/cooler/drain of a first make/model/brand/size, while the system 300B may be used for a container/cooler/drain of a second make/model/brand/size.

Although various embodiments have been described with reference to the Figures, other embodiments are possible. For example, air and/or water holes/conduits may come in different shapes and volumes. In various embodiments, drain plug adaptors may come in various sizes to fit different size containers. In some examples, drain plug adaptors may be various lengths to accommodate different widths/depths of containers. In various implementations, a 4-in-1 system may be employed not just for coolers, but may be a solution for our own (bait) buckets.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A bi-directional air and water conduit system comprising:
an adapter casing;
an internal member releasably coupled to the adapter casing;
a plurality of channels longitudinally extending throughout the internal member; and
the adapter casing, internal member, and plurality of channels configured to permit fluid egress and ingress a container.

2. The bi-directional air and water conduit system of claim 1, further comprising a fixating structures on the adapter casing, the fixating structures being configured to releasably couple to the container.

3. The bi-directional air and water conduit system of claim 1, further comprising a cap that is configured to releasably couple to the fixating structures of the adapter casing.

4. The bi-directional air and water conduit system of claim 1, wherein the plurality of channels are mutually isolated and assigned a specific purpose in facilitating fluid egress and ingress.

5. A bi-directional air and water conduit system comprising:
a longitudinally extending internal member;
a plurality of conduits extending longitudinally within the internal member;
an adapter casing configured to insert internal member into a hollow interior of the adapter casing.

6. The bi-directional air and water conduit system of claim 5, wherein the adapter casing includes fixating structure at a distal end of the adapter casing, the fixating structures configured to engage with a drain of a cooler.
